(19) United States
(12) Patent Application Publication
(10) Pub. No.: US 2021/0375540 A1
(43) Pub. Date: Dec. 2, 2021

(54) INTEGRATED MAGNETIC DEVICE WITH LAMINATE EMBEDDED MAGNETIC CORE

(71) Applicant: TEXAS INSTRUMENTS INCORPORATED, Dallas, TX (US)

(72) Inventors: Yuki Sato, Saitama-shi (JP); Kenji Otake, Nagano (JP); Zhemin Zhang, Allen, TX (US); Byron Lovell Williams, Plano, TX (US); Dongbin Hou, Plano, TX (US); Sombuddha Chakraborty, Redwood City, CA (US)

(21) Appl. No.: 17/240,656

(22) Filed: Apr. 26, 2021

Related U.S. Application Data
(60) Provisional application No. 63/031,115, filed on May 28, 2020.

(51) Int. Cl. H01F 41/04; H01F 17/00; H01F 17/04

(52) U.S. Cl. CPC H01F 41/041; H01F 17/045; H01F 17/0013

(57) ABSTRACT

A laminate embedded core and coil structure comprises a magnetic core embedded in a laminate structure that includes two types of laminates. A first laminate embeds the coils of the structure and a second laminate fills space between the magnetic core and the first laminate, as well as space below the magnetic core and lower surface of the first laminate. The first and second laminates form a laminate structure that protects and improves isolation of the magnetic components. Solder resist encloses the laminate structure, magnetic core and coils. The laminate embedded core and coil structure may be assembled on a transformer leadframe of various types using non-conductive paste.

### CROSS-REFERENCE TO RELATED APPLICATION

This application claims priority on U.S. provisional application No. 63/031,115, entitled “INTEGRATED TRANSFORMER WITH LAMINATE EMBEDDING MAGNETIC CORES”, filed May 28, 2020, the content of which is incorporated by reference herein in its entirety.

### BACKGROUND

This disclosure relates generally to magnetic cores for magnetic devices, e.g., transformers, and more particularly to laminate embedded magnetic cores for magnetic devices and methods of manufacturing and assembling the same.

A magnetic core is a key component of transformers and other devices that operate at least in part on the principle of electromagnetic induction. Magnetic cores are formed in various shapes, some resembling individual capital letters, e.g., I-shaped core, C-shaped core, E-shaped core. Two or more of these cores may be combined to form a magnetic core structure, e.g., an EI-shaped core structure in which the I-shaped portion is stacked against the open end of the E-shaped portion. EI-shaped core structures have become popular choices for transformers because of the various benefits, e.g., efficiency and quality, they provide.

Manufacturing and assembling a multi-portion core structure, e.g., an EI-core structure, however, pose various challenges. During such processes, air bubbles may be undesirably introduced into the structure. Also, adjacent core portions, e.g., between the middle segment or leg of the E-shaped core and the I-shaped core, may not be properly filled. These issues may, in turn, lead to lower isolation capability and lower mechanical stability of the magnetic core structure. Moreover, the mechanical drilling that is performed after application of the solder resist to insert the E-shaped core may result in chipping out some solder resist leaving voids in the structure. These voids may adversely impact mechanical stability because they may create regions that are not supported with mold compound, which regions are more susceptible to cracking during the manufacturing process. A solution to these problems is desirable.

### SUMMARY

In accordance with an example, a method comprises applying a first laminate on and around a coil structure of a magnetic structure; forming a through opening in an interior area of the first laminate, the interior area defined by windings of the coil structure; inserting a magnetic core in the through opening; applying a second laminate between the first laminate and the magnetic core and to cover the through opening, the first and second laminates forming a laminate structure; and applying solder resist to enclose the laminate structure after inserting the magnetic core in the through opening.

In accordance with an example, a magnetic assembly comprises a magnetic core; a coil; a laminate structure covering the coil and extending around the magnetic core to embed the magnetic core and the coil in the laminate structure; and an upper layer of solder resist covering a top of the laminate structure and a lower layer of solder resist underlying the laminate structure.

In accordance with an example, a method comprises applying on a leadframe a structure including at least a layer of non-conductive paste in contact with the leadframe; placing on the structure a laminate embedded magnetic core and coil structure; and applying a layer of non-conductive paste on a top of the laminate embedded magnetic core and coil structure.

### BRIEF DESCRIPTION OF THE DRAWINGS

Features of the disclosure may be more fully understood from the following figures taken in conjunction with the detailed description.

FIGS. 1A and 1B are diagrams of an example of multiple segments of a magnetic core structure embedded in a laminate structure.

FIGS. 2A and 2B are diagrams of an example of a segment of a magnetic core structure embedded in a laminate structure.

FIG. 3 is diagram of another example of multiple segments of a magnetic core structure embedded in a laminate structure.

FIG. 4 is a flow diagram of an exemplary process of embedding a magnetic core in a laminate structure.

FIG. 5A is a flow diagram of an exemplary process of assembling a structure of a transformer with a laminate embedded magnetic core, and FIG. 5B is a view of a partially assembled structure.

FIG. 6A is a flow diagram of an exemplary process of assembling a structure of a transformer with a laminate embedded magnetic core, and FIG. 6B is a view of a partially assembled structure.

FIG. 7 is a perspective view of an example of a transformer with a laminate embedded magnetic core and coil structure.

### DETAILED DESCRIPTION

Specific examples are described herein in detail with reference to the accompanying figures. These examples are not intended to be limiting. In the drawings, corresponding numerals and symbols generally refer to corresponding parts unless otherwise indicated. The objects depicted in the drawings are not necessarily drawn to scale.

The terms “magnetic core,” “core” and the like as used herein, refers to one or more segments or portions of a magnetic core assembly. Relative terms “top,” “bottom,” “below,” “upper” and the like indicate relative position with respect to the orientation being described or as shown in the drawing under discussion; such terms do not indicate absolute position or orientation. These terms do not require that any device or structure be constructed or operated in a particular orientation.

Examples of an improved laminate embedded magnetic core and processes of making/assembling the same are provided. One or more segments of a magnetic core structure and coils of the structure are pre-laminated, i.e., embedded in a laminate structure, and that structure is covered with solder resist before transformer assembly. Doing so, advantageously reduces or eliminates formation of air bubbles and unfilled areas to improve manufacturability, isolation capability and mechanical stability of the magnetic core structure and transformer or other device in which the solder-resist enclosed laminate structure is embodied.

Also provided are examples of improved transformer assembly processes using the laminate embedded magnetic core.

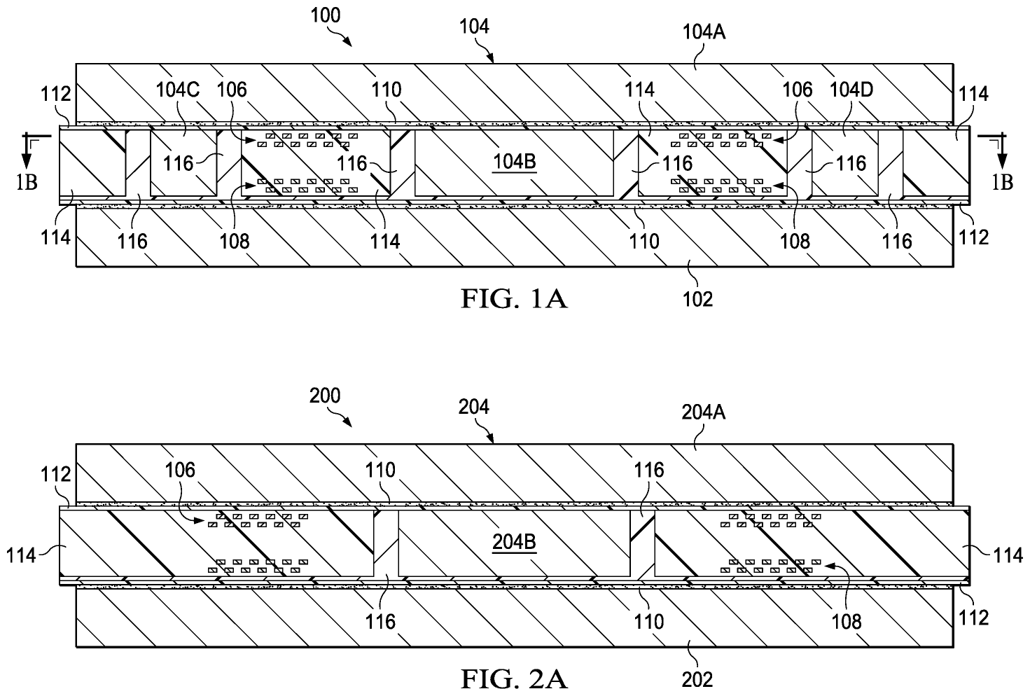

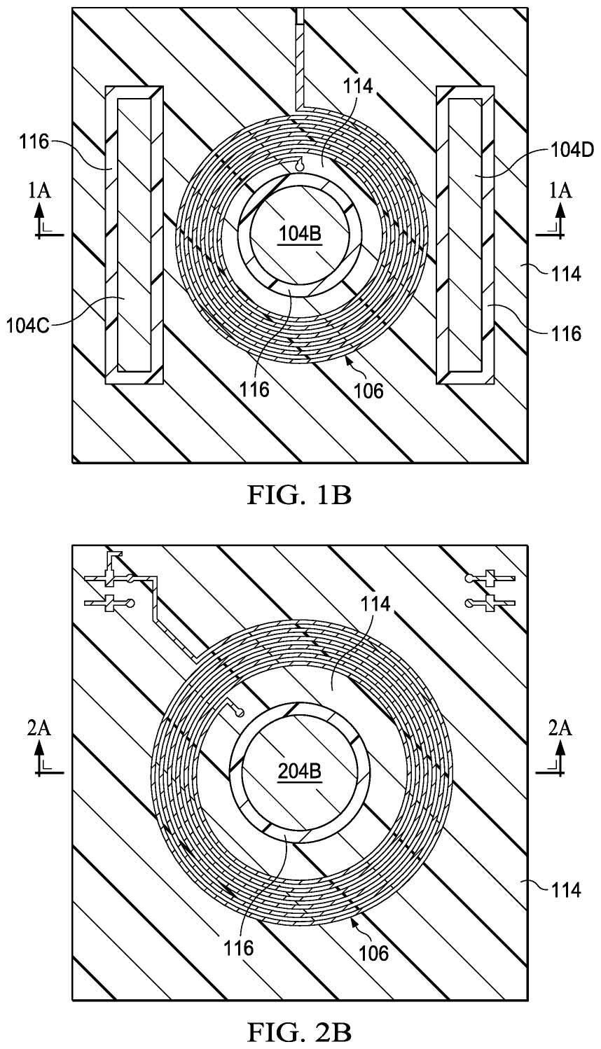

FIG. 1A is a cross-sectional view of a magnetic assembly 100, and FIG. 1B is a cross-sectional view of FIG. 1A. Magnetic assembly 100 includes an I-shaped magnetic core portion 102 and a magnetic core portion 104, the latter of which includes a magnetic stem section 104A, a magnetic center core segment 104B and two magnetic side core segments 104C and 104D. In this example, stem section 104A, center core segment 104B, and individual side core segments 104C and 104D are separate pieces configured to form an “E” shape.

Referring to FIGS. 1A and 1B (collectively, FIG. 1), primary coil 106 and secondary coil 108 are formed by primary and secondary windings, respectively, around center core segment 104B. The number of turns of each of the primary and secondary windings may be set based on the particular application. An electrically non-conductive paste 110 adheres to the upper surface of I-shaped core portion 102 and the lower surface of stem 104A of core portion 104. A layer of solder resist 112 is formed on top of the layer of non-conductive paste 110 formed on I-shaped core portion 102. Another layer of solder resist 112 is formed on the bottom of the layer of non-conductive paste 110 formed on the lower surface of stem 104A. The primary and secondary coils 106 and 108 are thus enclosed from the top and bottom by the two layers of solder resist 112, as best shown in FIG. 1A.

Between the two layers of solder resist 112 is a first laminate 114, e.g., Bismaleimide-Triazine (BT) laminate, in which primary and secondary coils 106 and 108 are embedded. First laminate 114 is also disposed to the exteriors of side core segments 104C and 104D, respectively, as shown in FIG. 1A. A second laminate 116, which may be an insulating layer, such as Ajinomoto Build-up Film (ABF), is disposed around and in contact with core segments 104B, 104C and 104D to fill the spaces between those segments and first laminate 114. Second laminate 116 also fills gaps below core segments 104B, 104C and 104D between those segments and the lower layer of solder resist 112, as well as between lower surfaces of first laminate 114 and the lower layer of solder resist 112.

Collectively, first laminate 114 and second laminate 116 form a laminate structure in which core segments 104A, 104B and 104C are embedded to fill the spaces between adjacent core segments, spaces exterior to side core segments 104C and 104D, as well as space below core segments 104B, 104C and 104D. The laminate structure is enclosed from a top and bottom perspective of FIG. 1A by solder resist 112.

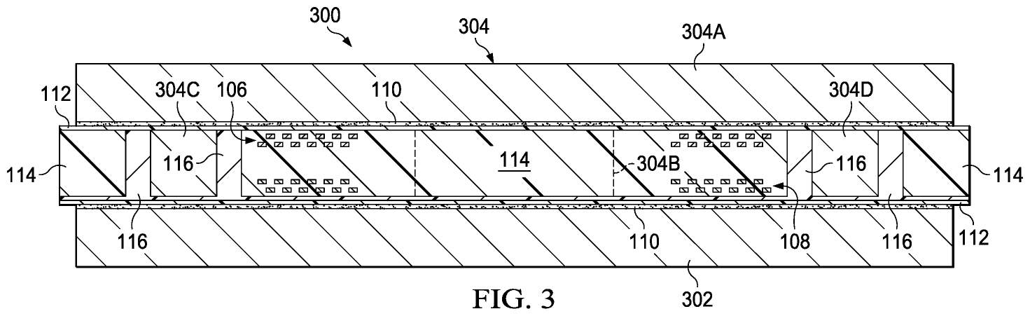

FIGS. 2A, 2B, and 3 show other configurations of laminate embedded magnetic core structures.

FIG. 2A is a cross-sectional view of a laminate embedded center core segment 204B of a magnetic assembly 200, and FIG. 2B is a cross-sectional view of FIG. 2A. That is, FIGS. 2A and 2B (collectively, FIG. 2) show an example in which only one of multiple segments, e.g., a center core segment 204B of a core portion 204, is embedded in the laminate structure formed by first laminate 114 and second laminate 116. Alternatively, in this example, core portion 204 may include only one segment, e.g., center core segment 204B, which segment is embedded in the laminate structure. In either case, core segment 204B is disposed between stem 204A of core portion 204 and I-shaped core portion 202.

As in the example of FIG. 1, in the example of FIG. 2, second laminate 116, e.g., ABF, is disposed around and in contact with the embedded core segment, e.g., center core segment 204B, to fill the spaces between that segment and first laminate 114, which embeds primary and secondary coils 106 and 108, respectively. Second laminate 116 also fills gaps between the lower extremity of core segment 204B and the lower layer of solder resist 112, as well as gaps between the lower surfaces of first laminate 114 and the lower layer of solder resist 112.

A lower layer of non-conductive paste 110 adheres to the upper surface of I-shaped core portion 202 and to the lower layer of solder resist 112. An upper layer of non-conductive paste 110 adheres to the lower surface of stem 204A of core portion 204 and to the upper layer of solder resist 112.

The upper and lower layers of solder resist 112 enclose from a top to bottom perspective the laminate embedded core, i.e., core segment 204B and primary and secondary coils 106 and 108, all of which are embedded in the laminate structure formed by first and second laminates 114 and 116.

FIG. 3 shows an arrangement in which two side core segments 304C and 304D of magnetic assembly 300 are embedded. The two side core segments 304C and 304D are disposed between stem 304A of core portion 304 and I-shaped core portion 302. Magnetic assembly 300 may also have a center core segment 304B, which is shown by hidden lines.

In the example of FIG. 3, primary and secondary coils 106 and 108, as well as center core segment 304B, are embedded in first laminate 114, which also surrounds each of side core segments 304C and 304D. Second laminate 116 fills the space between each side core segment 304C and 304D and the first laminate 114, as well as the space below first laminate 114 and side core segments 304C and 304D. Thus, together laminates 114 and 116 form a laminate structure in which side core segments 304C and 304D are embedded. From a top and bottom perspective of FIG. 3, the laminate structure is enclosed from by layers of solder resist 112, which is enclosed by layers of non-conductive paste 110.

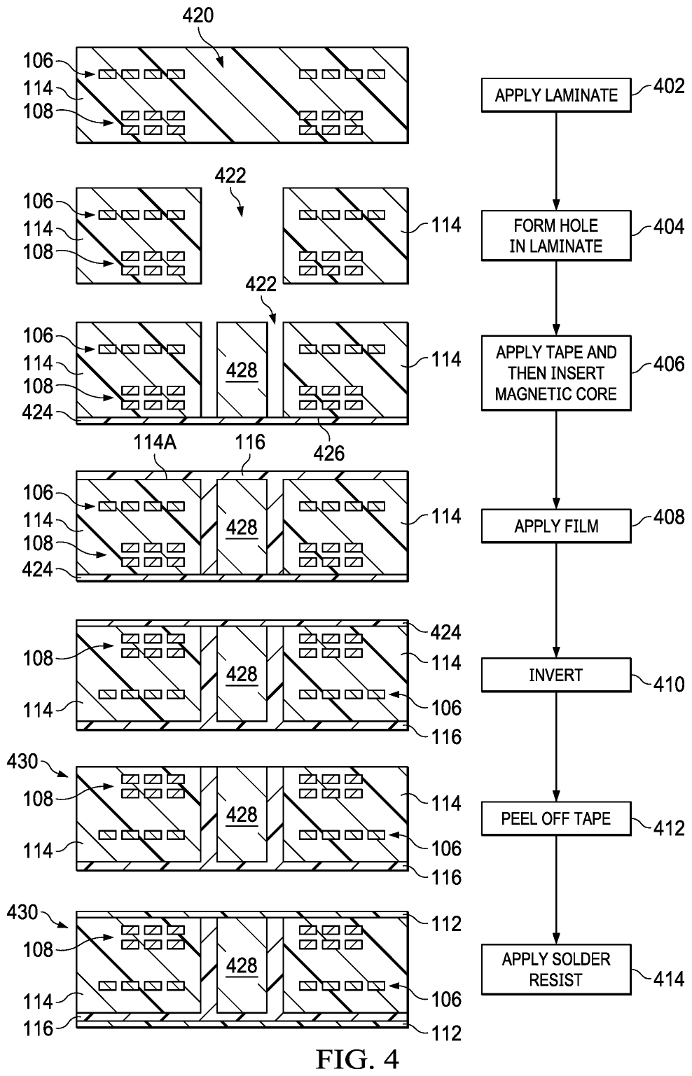

FIG. 4 is a flow diagram showing an exemplary process of embedding a magnetic core or segment thereof. In operation 402, primary and secondary coils 106 and 108 are covered with, or embedded in, first laminate 114, which may be BT laminate. The windings of primary and secondary coils 106 and 108 form an interior area 420 in first laminate 114. In operation 404, a hole 422, such as a through opening open to the top and bottom of the structure, is formed in interior area 420 of first laminate 114. Hole 422 may be formed by drilling or any other suitable technique. In operation 406, tape 424 is applied to a bottom surface 426 of first laminate 114. Tape 424 is applied such that the bottom opening of hole 422 is covered. Operation 404 also involves inserting a magnetic core 428 in hole 422 such that the lead insertion end of magnetic core 428 contacts tape 424. In operation 408, an insulating film such as ABF (second laminate 116), is applied or deposited between first laminate 114 and magnetic core 428. Second laminate 116 is also applied or deposited on top surface 114A of first laminate 114 and to cover the top opening of hole 422. Together, first and second laminates 114 and 116 form a laminate structure that enclose magnetic core 428, primary coil 106 and secondary coil 108.

In operation 410, the entire structure thus far assembled is inverted to make it easier to peel off or remove tape 424, which is done in operation 412. Removal of tape 424, yields a laminate embedded core and coil structure 430. In operation 414, solder resist 112 is applied to top and bottom surfaces of laminate embedded core and coil structure 430 as shown.

The exemplary process depicted in FIG. 4 may avoid or reduce formation of air bubbles in the areas occupied by the laminate structure, i.e., laminates 114 and 116, to provide better isolation. Moreover, by applying solder resist 112 after forming hole 422 avoids chipping or otherwise damaging the solder resist in the drilling process. As a result, mechanical stability of laminate embedded core and coil structure 430 may be improved.

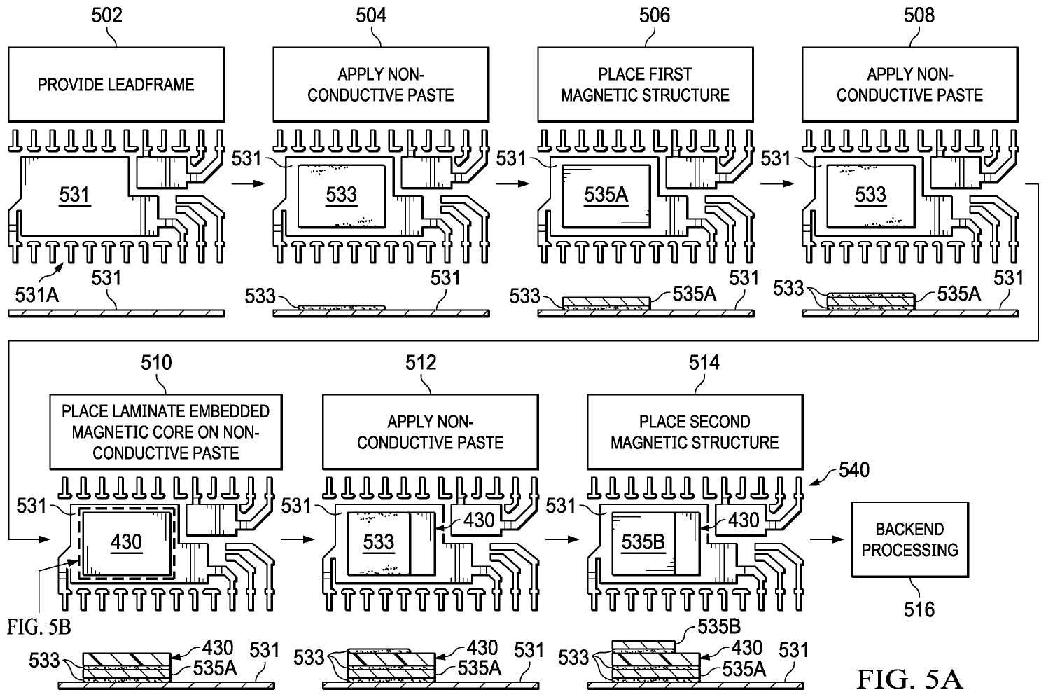

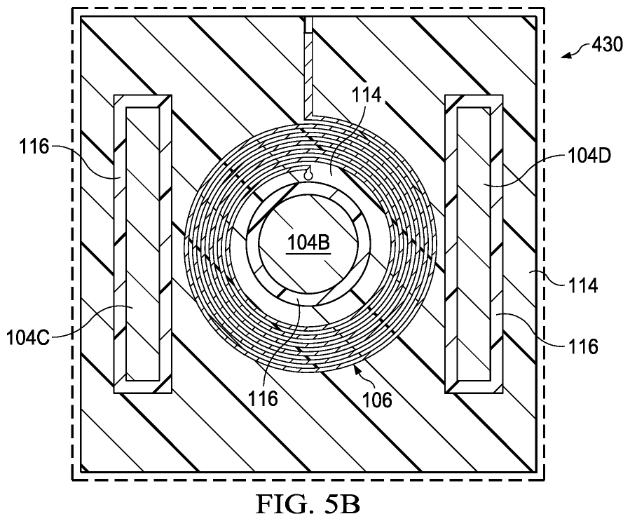

FIG. 5A is a flow diagram of a process of assembling a structure of a transformer with a laminate embedded magnetic core according to an example in which magnetic structures are placed on one side of a nonsymmetric leadframe. Each operation of FIG. 5A is illustrated with plan and cross-sectional views. In operation 502 of the process a leadframe 531 is provided. Leadframe 531 includes a plurality of conductive leads generally indicated by reference numeral 531A. In this example, leadframe 531 may be an offset cantilever type leadframe.

In operation 504, a layer of electrically non-conductive, e.g., die attach, paste 533 is applied or deposited on leadframe 531. A first magnetic structure 535A is then placed on the layer of non-conductive paste 533 in operation 506. In operation 508, another layer of non-conductive paste 533 is applied or deposited on top of magnetic structure 535A, such that magnetic structure 535A is sandwiched between layers of non-conductive paste 533.

In operation 510, laminate embedded core and coil structure 430 is placed on the top layer of non-conductive paste 533, i.e., the layer applied in operation 508. A cross-sectional view of laminate embedded core and coil structure 430, which may be manufactured or assembled according to the process of FIG. 4, is shown in FIG. 5B, which is similar to FIG. 1B. Laminate embedded core and coil structure 430 includes magnetic core 104B and surrounding coils 106, 108 embedded in laminates 114 and 116.

In operation 512, a third layer of non-conductive paste 533 is applied or deposited on at least a portion of the top surface of laminate embedded core and coil structure 430. A second magnetic structure 535B is then placed on the third layer of non-conductive paste 533 in operation 514, yielding transformer structure 540.

In the structure assembled according to the process of FIGS. 5A and 5B, laminate embedded core and coil structure 430 is enclosed between layers of non-conductive paste 533 with magnetic structure 535A adjoining one of the non-conductive paste layers and magnetic structure 535B adjoining the other non-conductive paste layer. Pick-and-place technology may be used for the magnetic structures 535A, 535B and pre-formed laminate embedded core and coil structure 430 to facilitate assembly of transformer structure 540.

The example process of FIG. 5A may further include various backend processing 516 that may include wire bonding, other interconnection processing, molding, trim, and forming as is known in the art to complete assembly of transformer structure 540.

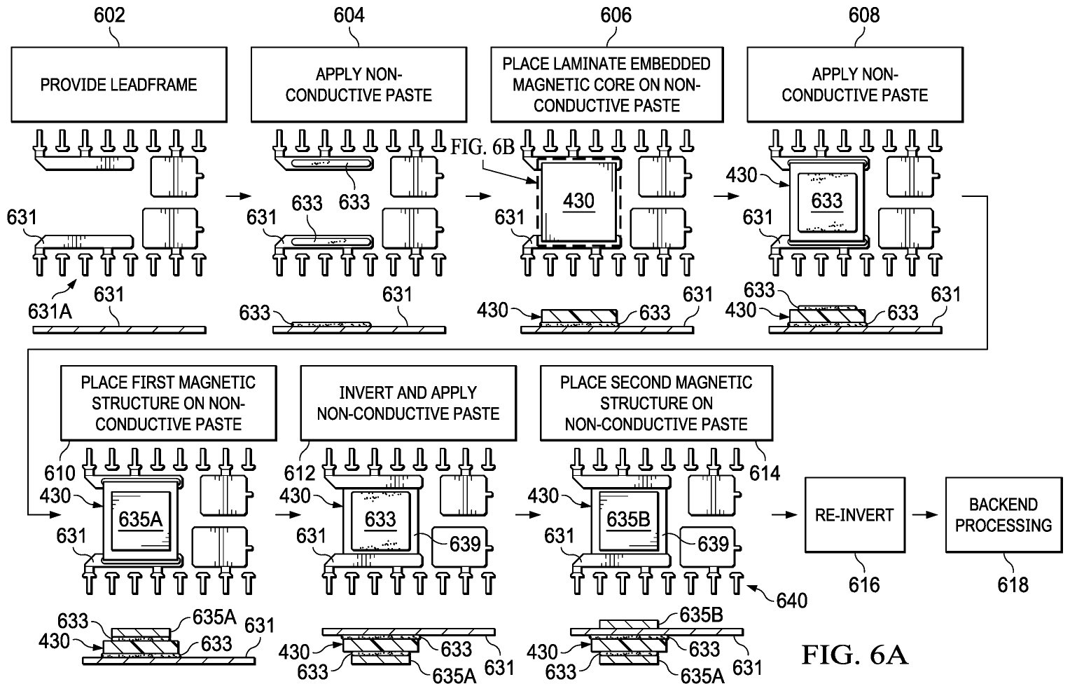

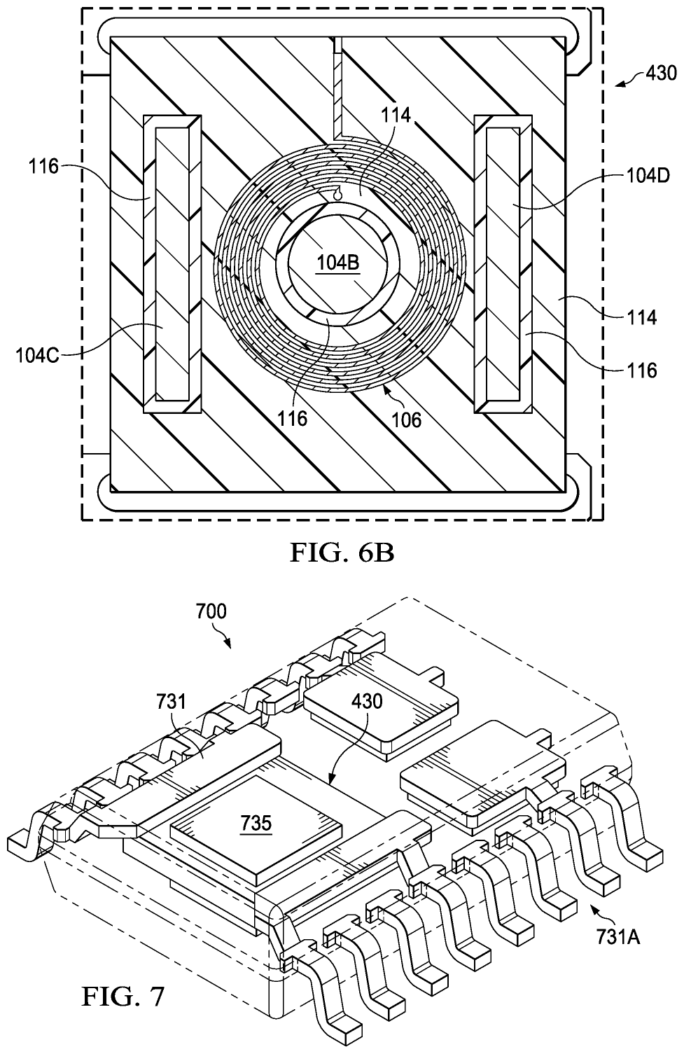

FIG. 6A is a flow diagram of a process of assembling a transformer with a laminate embedded magnetic core according to another example in which magnetic structures are placed on both sides of a non-symmetric leadframe. Each operation of FIG. 6A is illustrated with plan and cross-sectional views. In operation 602 of the process a leadframe 631 is provided. Leadframe 631 includes a plurality of conductive leads generally indicated by reference numeral 631A.

In operation 604, non-conductive, e.g., die attach, paste 633 is applied or deposited on leadframe 531. Non-conductive paste 633 may be applied in strips as shown. In operation 606, laminate embedded core and coil structure 430 is placed on top of non-conductive paste 633. Laminate embedded core and coil structure 430, which includes magnetic core 104B and surrounding coils 106, 108 embedded in laminates 114 and 116, may be manufactured or assembled according to the process of FIG. 4. A cross-sectional view of laminate embedded core and coil structure 430 is shown in FIG. 6B, which is similar to FIG. 1B.

In operation 608, a layer of non-conductive paste 633 is applied or deposited on at least a portion of the top surface of laminate embedded core and coil structure 430. In operation 610, a first magnetic structure 635A is then placed on the layer of non-conductive paste 633 deposited in operation 608.

In operation 612, the structure is inverted and a layer of non-conductive paste 633 is applied or deposited on the bottom surface 639 of laminate embedded core and coil structure 430. In this example, in the inverted orientation bottom surface 639 is below the now upper edge of leadframe 631. In operation 614, a second magnetic structure 635B is placed on the layer of non-conductive paste 633 applied in operation 612. Then, the transformer structure 640 is reinverted, i.e., returned to its original assembly orientation, in operation 616.

The example process of FIG. 6A may further include various backend processing 618 that may include wire bonding, other interconnection processing, molding, trim, and forming as is known in the art to complete assembly of transformer structure 640.

In the structure assembled according to the process of FIGS. 6A and 6B, laminate embedded core and coil structure 430 is sandwiched between layers of non-conductive paste 633 with magnetic structures 635A and 635B positioned outwardly of the two non-conductive paste layers, respectively. Pick-and-place technology may be used for the magnetic structures 635A, 635B and pre-formed laminate embedded core and coil structure 430 to facilitate assembly.

Each of the flow diagrams of FIGS. 4-6 depict one possible order of operations to achieve a particular structural arrangement. Other orders are possible. Some operations may be combined into a single operation. Additional may be performed as well.

An example of an assembled transformer including laminate embedded core and coil structure 430 is shown in FIG. 7. Laminate embedded core and coil structure 430 may be manufactured or assembled according to the process of FIG. 4. Transformer 700 includes leadframe 731 and conductive leads 731A. One magnet 735 is positioned on one side of laminate embedded core and coil structure 430 and another magnet is positioned on the other side.

By embedding magnetic core(s) in laminate before transformer assembly, better isolation and mechanical stability may be achieved. In particular, unfilled locations where air bubbles tend to form, i.e., voids, in the structure are eliminated or reduced, providing better isolation. Moreover, because solder resist is applied after hole formation, e.g., after mechanical drilling, the problem of solder resist being chipped out or otherwise damaged during drilling is avoided. Maintaining the structural integrity of solder resist also contributes to the improved isolation capability of the structures of the present disclosure. Pre-laminating magnetic core(s) also facilitates manufacture of laminate embedded core and coil structure 430, as well as end product, i.e., transformer, assembly.

First and second laminates 114 and 116 are not limited to BT laminate and ABF, respectively. In another example, first laminate 114 may be ABF and second laminate 116 may be BT laminate. In still another example, first and second laminates 114 and 116 may be the same, e.g., both may be ABF. More generally, first and second laminates 114 and 116 may be any suitable laminate or film type materials consistent with the teachings herein.

Modifications of the described examples are possible, as are other examples, within the scope of the claims. Moreover, features described herein may be applied in other environments and applications consistent with the teachings provided.

What is claimed is:

1. A method, comprising:
applying a first laminate on and around a coil structure of a magnetic structure;
forming a through opening in an interior area of the first laminate, the interior area defined by windings of the coil structure;
inserting a magnetic core in the through opening;
applying a second laminate between the first laminate and the magnetic core and to cover the through opening, the first and second laminates forming a laminate structure; and
applying solder resist to enclose the laminate structure after inserting the magnetic core in the through opening.

2. The method of claim 1, including:
applying tape to a bottom surface of the laminate structure extending across a bottom of the through opening before inserting the magnetic core in the through opening.

3. The method of claim 2, including:
removing the tape after applying the film.

4. The method of claim 2, in which the magnetic core is inserted such that one end of the magnetic core contacts the tape.

5. The method of claim 1, wherein the first laminate comprises Bismaleimide-Triazine (BT) laminate and the second laminate comprises Ajinomoto Build-up Film (ABF).

6. The method of claim 1, wherein the first laminate comprises Ajinomoto Build-up Film (ABF) and the second laminate comprises Bismaleimide-Triazine (BT) laminate.

7. The method of claim 1, wherein the first and second laminates are the same.

8. The method of claim 3, including:
inverting the magnetic component after applying the second laminate and before removing the tape.

9. The method of claim 1, wherein the second laminate is applied such that space between the first laminate and the magnetic core is completely filled.

10. A magnetic assembly, comprising:
a magnetic core;
a coil;
a laminate structure covering the coil and extending around the magnetic core to embed the magnetic core and the coil in the laminate structure; and
an upper layer of solder resist covering a top of the laminate structure and a lower layer of solder resist underlying the laminate structure.

11. The magnetic assembly of claim 10, wherein the laminate structure comprises Bismaleimide-Triazine (BT) laminate and Ajinomoto Build-up Film (ABF).

12. The magnetic assembly of claim 10, including:
an upper layer of non-conductive paste in contact with and on top of the upper layer of solder resist and a lower layer of non-conductive paste in contact with and below the lower layer of solder resist.

13. The magnetic assembly of claim 10, wherein the coil comprises primary and secondary coils, both of which are wound around the magnetic core.

14. The magnetic assembly of claim 10, wherein the magnetic core is part of a magnetic core structure that includes a first core section and a second core section, the magnetic core being positioned between the first and second core sections.

15. The magnetic assembly of claim 10, wherein the magnetic core is part of a magnetic core structure that includes a first core section and a second core section and the magnetic core comprises a plurality of magnetic core segments, each positioned between the first core section and the second core section.

16. A method, comprising:
applying on a leadframe a structure including at least a layer of non-conductive paste in contact with the leadframe;
placing on the structure a laminate embedded magnetic core and coil structure; and
applying a layer of non-conductive paste on a top of the laminate embedded magnetic core and coil structure.

17. The method of claim 16, including placing the laminate embedded magnetic core and coil structure on a layer of non-conductive paste on the top of a magnet which are part of the structure.

18. The method of claim 17, including:
applying a layer of non-conductive paste on the laminate embedded magnetic core and coil structure; and
placing a magnet on the layer of non-conductive paste on the laminate embedded magnetic core and coil structure.

19. The method of claim 16, including:
placing a magnet on the layer of non-conductive paste on the top of the laminate embedded magnetic core and coil structure.

20. The method of claim 19, including:
applying a layer of non-conductive paste on a bottom surface of the laminate embedded magnetic core and coil structure, and
placing another magnet on the layer of non-conductive paste applied on the bottom surface of the laminate embedded magnetic core and coil structure.
